(19) United States
(12) Patent Application Publication
(10) Pub. No.: US 2026/0048439 A1
(43) Pub. Date: Feb. 19, 2026

(54) COMPONENT FOR RECEIVING AND CLAMPING A ROTOR

(71) Applicant: Schenck RoTec GmbH, Darmstadt (DE)

(72) Inventor: Volker BINSACK, Weiterstadt (DE)

(73) Assignee: Schenck RoTec GmbH, Darmstadt (DE)

(21) Appl. No.: 18/704,677

(22) PCT Filed: Oct. 27, 2022
(86) PCT No.: PCT/DE2022/100797

§ 371 Date: Apr. 25, 2024

(30) Foreign Application Priority Data
Nov. 1, 2021 (DE) 10 2021 128 423.6

(51) Int. Cl. B23B 31/117

(52) U.S. Cl. CPC B23B 31/1173

(57) ABSTRACT

In a component for receiving and clamping a rotor, a ring assembly enclosing a hollow space includes rings lying one inside the other and with connectors extending radially through the ring assembly, by which the rings are connected to one another in a rotationally fixed manner. At least two clamping elements projecting into the hollow space are attached to the ring assembly, which form a receptacle for the rotor with clamping surfaces. There are also weights on the ring assembly for centrifugal force compensation.

The invention relates to a component for receiving and clamping a rotor with a ring assembly comprising several rings, in which clamping elements for receiving the rotor and weights for centrifugal force compensation are present.

In order to measure loads acting on a rotating body, spin test rigs are used in which the body, such as a rotor, is operated in its operating speed range and above. In series production, it is also sometimes necessary to spin rotors in order to run through a settling behavior so that balancing is possible without subsequent unbalance changes during operation. In addition, the rotor can be exposed to cyclical speed changes or temperature fluctuations, for example. The rotor can be suspended and accelerated via its shaft journal on a thin, elastic shaft. The rotors must be detachably attachable to the centrifugal shaft for this purpose.

Known rotor clamping devices have centrifugal force segments to compensate for the effects of centrifugal force on the rotor tension.

DE 15 52 197 C discloses a centrifugal chuck for high-speed rotating tools with a plurality of chuck jaws that complement each other to form a chuck jaw set. The centrifugal chuck has centrifugal weights formed with the chuck jaws, which are pivotable as a two-armed lever about a lever pivot point. The centrifugal weights are arranged between two axially spaced chuck jaw sets and are each formed in one piece with one chuck jaw of the two chuck jaw sets. The chuck jaw sets project radially outwards between their ends to form the lever pivot points.

U.S. Pat. No. 2,830,822 A discloses a centrifugal chuck in which several weights are arranged around a rotor and thus move radially outwards as a result of the centrifugal force when the rotor rotates. The weights are also connected to a ring, which is connected to claws which are arranged on the rotor so that they can move radially. Due to the radially outward movement of the weights because of the centrifugal force, the parts of the ring connected to the weights are also pressed outwards, so that the claws connected to the intermediate parts of the ring are pulled together.

DE 42 20 136 C1 discloses a clamping system for machine tools for clamping rotationally oriented tools and/or workpieces with a chuck or base body, a clamping gear, base jaws and top jaws. The top jaws consist at least partially of fiber composite plastics, whereby the chuck body, the clamping gear, the base jaws and the interface between the base jaws and the top jaws are made of a metallic material. Centrifugal balancing weights are arranged on the bandage made of fiber composite plastics between the clamping elements in such a way that they can move together with the bandage made of fiber composite plastics in the radial direction and are fixed in the tangential direction. As the speed increases and the centrifugal force thus increases outwards, the fiber composite plastic drum is moved outwards.

Furthermore, DE 198 34 739 C1 describes a clamping device in which a polygon-shaped base body is elastically formed into a round shape. In this process, areas of the base body located between the force application points are deformed in such a way that the mount widens and a round shaft can be fitted. As soon as the radial forces acting on the base body are reduced or even eliminated, the base body returns to its original polygonal shape due to its elastic properties and the shaft is fixed in the receptacle. EP 1 669 621 B1 adopts this teaching and inserts centrifugal balancing weights into cavities that are present in the base body, so that the centrifugal balancing weights are pressed outwards due to centrifugal forces that occur. This bends the intermediate areas inwards and increases the clamping force on the shaft.

DE 907 233 B describes a variable-diameter, tubular workpiece holder for machine tools, which has clamping surfaces projecting beyond the diameter of the part to be held and extending only over parts of its circumference, which can be adjusted to the workpiece diameter with elastic deformation of the areas of the holder located between them.

DE 10 2020 113 330 B3 discloses a component for connecting a shaft to a clamping device that can accommodate a rotor, whereby the clamping device can be inserted into a pot-shaped housing and can be fixed there by means of fastening means. Connection means are provided on the base of the housing to connect the housing to the shaft in a rotationally fixed manner. The fastening means have at least one recess in the base surface, so that their base surface only rests on the outer casing surface in certain areas.

The problem with the known clamping devices is that high centrifugal forces are generated due to high speeds, which lead to a reduction in the clamping forces. In addition, the clamping devices are expensive to manufacture and maintain. Unclamping the devices is also cumbersome. A major disadvantage is that the clamping devices cannot be adapted, i.e. due to their design and composition, they achieve correspondingly defined clamping forces.

The invention is based on the task of providing a device for clamping a rotor in which the tension of the rotor is not impaired by strong centrifugal forces and which is easy to adjust.

The problem is solved by the features of claim 1. Preferred embodiments are described in the dependent claims.

According to the invention, the task is solved by providing a component for receiving and clamping a rotor, with a ring assembly enclosing a hollow space, comprising a plurality of rings lying one inside the other and with connecting means which extend radially through the ring assembly, by means of which the rings are connected to one another in a rotationally fixed manner, wherein at least two clamping elements projecting into the hollow space are attached to the ring assembly, and form a receptacle for the rotor with clamping surfaces and wherein weights for centrifugal force compensation are present on the ring assembly. The rings of the ring assembly basically behave like leaf springs, which are approximately rigid under tensile load. As a result, the clamping elements are pulled inwards when the weights acting as centrifugal force segments move outwards. This means that the clamping force is not adversely affected by high centrifugal forces. The main advantage of the component is that, due to its design, it can be easily adapted to different types of clamping tasks, for example by changing the number of rings and thereby changing the flexibility or elasticity of the ring assembly. This allows solutions for different clamping forces and operating speeds to be adapted. High speeds in particular can be realized.

To clamp a rotor, external pressure can be applied to the component, in particular the weights, so that the centrifugal force segments move inwards and the clamping elements move outwards. This enables quick and easy unclamping.

The component can be part of a fully automated coupling device in which the rotor to be clamped is automatically clamped and unclamped. The component can also be used to clamp a rotor in a spin test rig.

In one embodiment, it is possible that the clamping elements are Y-shaped and form clamping surfaces for the rotor to be accommodated with their two legs. The clamping elements therefore have a simple structure that is inexpensive to manufacture. The clamping elements can be designed in one or more parts and have hollow spaces to save weight. The one-piece design has advantages in production, whereas a multi-piece design of the clamping elements has advantages in assembly and maintenance.

It may also be possible to create rotor-specific clamping pieces. This allows non-round geometries to be clamped. For example, a gear profile can be clamped with a shaped clamping piece. This can increase the range of applications and the transmittable torque.

It may also be provided that the clamping elements are attached to the connecting means, in particular to the connection points formed by the connecting means. The connecting means can, for example, be designed as a screw/nut connection, rivets or bolts and pass radially through the ring assembly. For the purposes of the invention, the connecting means serve to connect the rings to each other in a rotationally fixed manner. The connecting means can also be in the form of material-locking connections that extend radially through the rings and connect them in a non-rotatable manner.

The clamping elements can be attached to the receptacles of the connecting means or to the connection point using appropriate fastening means. For example, a screw connection, tongue and groove connection, dovetail connection, other plug-in connection or a combination thereof can be provided between the connecting means, in particular the connection point and the clamping element, so that the clamping elements can be reversibly attached to the ring assembly but can withstand high speeds. This simplifies maintenance of the component. This is because the clamping element can be easily replaced if necessary.

The rotor can be clamped by two clamping elements arranged diametrically in the ring assembly. This makes it easier to clamp rotors that deviate from a cylindrical design. However, it is also possible to have three equally spaced clamping elements in the ring assembly. This design is particularly advantageous when clamping heavy rotors.

In order to achieve the best possible transmission of torque to the rotor or its shaft journal, it is intended that the legs of the clamping elements form a concave clamping surface, which wraps around a large surface of a shaft journal of a rotor.

In one embodiment, the clamping surfaces are coated with a layer that increases the friction between the clamping surfaces and the rotor surface. This improves the transmission of torque. Furthermore, the layer can be easily removed and thus adapted to the diameter of the rotor to be accommodated. If necessary, the layer can be removed in certain areas before the rotor is clamped.

To make it easier to pass the connecting means through the rings, the rings can have coaxial bores for the radially extending connecting means to pass through. The bores can have a collar that engages in the subsequent bore so that the rings can be connected to each other without connecting means. In addition, the bores can have internal threads that interact with the corresponding external threads of the connecting means. The connecting means can also be in the form of material-locking connections that extend radially through the rings. In this embodiment, the bores can be dispensed with.

The weights for centrifugal force compensation are present on the ring assembly, in particular its outer circumference. In one embodiment, it is intended to attach the weights to further connecting means not connected to clamping elements or to the connecting points formed by the connecting means, so that the weights are advantageously present at one end of the connecting means or connecting point close to or on the outer circumference of the ring assembly. For this purpose, the weights can, for example, have a counter sunk hole through which the connecting means are guided before they engage in the rings.

Spacer means may be present between the rings. In one embodiment, the spacer means have bores and are aligned in such a way that their bores are concentric with those of the rings. Due to the spacer means, the distance between the rings remains constant and the rings are not damaged by the connecting means or the force acting on the rings. The spacers can be arranged in the form of metal plates between two rings, preferably several distributed around the circumference. The fit can be improved by the spacer means having a concave and an opposite convex side.

For high precision requirements, it is possible to pre-position the complete assembly in a device in the clamping position and grind the complete unit onto a suitable clamping surface. This enables precise guidance of the clamping device in the operating position. The process makes it possible to compensate for any manufacturing inaccuracies in the individual components.

The invention is explained in more detail below with reference to an embodiment of the invention, which is shown in the drawing. It shows

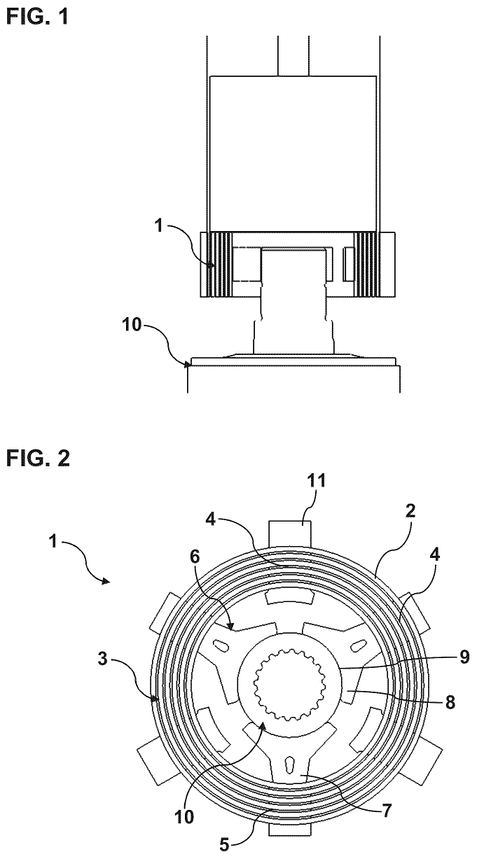

FIG. 1 a sectional view of an embodiment of the component with a mounted rotor and

FIG. 2 a cross-section through the component shown in FIG. 1.

FIG. 1 shows a sectional view of an embodiment of the component with a mounted rotor and FIG. 2 shows a cross-section through the component as shown in FIG. 1. The component 1 has several rings 2 with different diameters, which are arranged one inside the other and thus form a ring assembly 3. The rings 2 can, for example, be made of metal or a plastic, in particular a fiber-reinforced plastic, and be designed as a hollow cylinder. The thickness of the rings 2 can be the same for all rings 2. The number of rings 2 can vary depending on the clamping task.

The rings 2 can have bores, not shown, which are arranged coaxially to one another and form radially extending passages into which the connecting means 4 can be inserted or passed. Spacer means 5 can be arranged between the rings 2 around the bores forming the passages, which can also have a bore for the passage of the connecting means 4. The bore of the spacer means 5 can have an internal thread in order to make the connection of the rings 2 more stable. The thickness of the spacer means 5 can be adapted to the desired thickness of the ring assembly 3 as required. It can also be advantageous for the spacer means 5 to each have a convex and a concave side surface. For example, metal, plastic or a combination thereof can be used as the material of the spacer means 5.

The connecting means 4 can be designed as a screw/nut connection, rivet or bolt, which are guided through the passages and connect the rings 2 to each other so that they cannot rotate. The connecting means 4 can also be designed as a material-locking connection, so that connections by e.g. gluing, soldering or welding are possible.

Y-shaped clamping elements 6, which have a base 7 and two legs 8, are arranged on at least two connecting means 4. The base 7 can, for example, be connected to the connecting means 4 or the ring assembly 3 via a screw connection, although a plug-in connection or a combination thereof can also be provided so that the clamping elements 6 can be replaced, for example during maintenance. The two legs 8 of the Y-shaped clamping elements 6 each form concave clamping surfaces 9 for receiving a rotor 10. Two clamping elements 6 can be diametrically opposed in the ring assembly 3. However, it may also be preferable for three clamping elements 6 to be arranged evenly spaced apart, for example at an angle of 120° to each other in the ring assembly 3. There is advantageously a free space between the legs 8 of adjacent clamping elements 6 that form the clamping surfaces 9, whereby the free space can be smaller or larger depending on the design of the clamping elements 6. The clamping elements 6 can be made of a metal or a fiber-reinforced plastic and have one or more cavities to save weight. It can also be advantageous if the clamping surfaces 9 are coated with a layer that increases the friction between the clamping surfaces 9 and the rotor surface, which improves the transmission of the torque.

Weights 11, for example in the form of metal parts, which can be reversibly attached to the connecting means 4, for example, are provided at other connection points of the rings 2 not fitted with clamping elements 6 and produced by connecting means 5. The weights 11 are arranged in particular on the outer circumference of the ring assembly, for example by the weights 11 having a countersunk bore through which the connecting means 4 are guided into the bores of the rings 2. Different weights 11 can be used, which are interchangeable depending on the clamping device. It is also possible to attach the weights 11 to the inner circumference of the ring assembly 3.

The component 1 can have means by which it and the rotor 10 accommodated therein are attached to a drive shaft. It is also possible for the component 1 to be inserted into another component, which in turn can be connected to a drive shaft.

When the rotor 10 is rotating, the clamping elements 6, connecting means 4 and the weights 11 develop centrifugal forces. The connecting means 4 with the weights 11 advantageously have a higher weight than the connecting means 4 with the clamping elements 6 and act as centrifugal force segments-they generate somewhat greater centrifugal forces than the connecting means 4 with the clamping elements 6. As the rings 2, in particular the ring assembly 3, is approximately rigid under tensile load, the clamping elements 6 are pulled inwards when the weights 11, which act as centrifugal force segments, move outwards. This prevents the rotor tension from being released even at high speeds and correspondingly strong centrifugal forces. On the contrary: The faster the component 1 according to the invention rotates and the higher the centrifugal forces are, the more the weights 11 are pulled outwards and the clamping elements 6 are pulled inwards. If the masses of the connecting means 4 are the same, the ratio of the masses and centers of gravity of the clamping elements 6 to the masses and centers of gravity of the weights 11 essentially determines how much the clamping force increases with increasing rotational speed.

To accommodate a rotor 10 or a shaft journal of a rotor 10, the weights 11 are pressed inwards with a force from the outside. This causes the clamping elements 6 to move outwards. Unclamping can be done manually or with an auxiliary device. This can be a cylinder, for example, which presses on one weight 11, while the other two weights 11 of component 1 are fixed in two fixed stops. However, three synchronized cylinders can also be used, which press simultaneously on the weights 11. As the rings 2 or ring assembly 3 are/is rigid in their longitudinal directions, the clamping elements 6 move outwards when the weights 11 move inwards. Without the effect of a force on the weights 11, the rings 2 generate a preload force that presses the clamping elements 6 onto the surface of the rotor 10 or the shaft journal so that it is centered and torques are transmitted in a frictionally engaged manner.

The component 1 according to the invention can be used, for example, to clamp rotors and detachably fasten them to a shaft, in particular a centrifugal shaft of a centrifugal test stand. However, the component 1 can also be used for other clamping tasks in which a rotor or a rotating workpiece has to be clamped. For example, component 1 can be inserted into a rotating machine and held there. The variability of the number of rings 2 in particular means that component 1 can be easily adapted to the clamping task. In addition, maintenance, assembly and disassembly of the component 1 can be carried out easily.

The parts of component 1 can be made of different materials and can be easily joined together, which in turn considerably simplifies assembly and maintenance. In addition, the parts of component 1 can be provided with different physical properties. For example, it can be advantageous if the rings 2 and the clamping elements 6 are made of a fiber composite material, while the connecting means 4 are made of a metal.

The main advantages of the component 1 according to the invention are that higher speeds are possible, a higher load capacity improves the clamping options and more flexibility is possible when designing the clamping elements 6. Furthermore, higher clamping forces can be achieved and longer cycle times can be achieved. It has also been shown that the design of the weights 11 and the variable number of rings 2 allow clamping forces to be adapted to different motors or rotor geometries and applications.

1: A component (1) for receiving and clamping a rotor (10) with a ring assembly (3) enclosing a hollow space, comprising a plurality of rings (2) lying one inside the other and with connecting means (4) which extend radially through the ring assembly (3) and by means of which the rings (2) are connected to one another in a rotationally fixed manner, wherein at least two clamping elements (6) projecting into the hollow space are attached to the ring assembly (3) and form a receptacle for the rotor (10) with clamping surfaces (9), and wherein weights (11) for centrifugal force compensation are present on the ring assembly (3).

2: The component (1) according to claim 1, wherein the clamping elements (6) are Y-shaped and form the clamping surfaces (9) for the rotor (10) to be accommodated with their two legs (8).

3: The component (1) according to claim 1, wherein the clamping elements (6) are attached to the connecting means

4: The component (1) according to claim 1, wherein two diametrically arranged clamping elements (6) are present in the ring assembly (3).

5: The component (1) according to of the claim 1, wherein three clamping elements (6) are present in the ring assembly (3), which are evenly spaced apart from one another.

6: The component (1) according to claim 2, wherein the legs (8) of the clamping elements (6) form a concave-shaped clamping surface (9).

7: The component (1) according to claim 1, wherein the clamping surfaces (9) are coated with a layer which increases the friction between the clamping surfaces (9) and the rotor surface.

8: The component (1) according to claim 1, wherein the rings (2) have bores lying coaxially to one another for passing through the radially extending connecting means (4).

9: The component (1) according to claim 1, wherein weights (11) for centrifugal force compensation are present on further connecting means (4) not connected to the clamping elements (6).

10: The component (1) according to claim 9, wherein the weights (11) are present at one end of the connecting means (4) close to the outer circumference of the ring assembly (3).

11: The component (1) according to claim 1, wherein spacer means (5) are present between the rings (2).
